(19) United States
(12) Patent Application Publication
(10) Pub. No.: US 2020/0145153 A1
(43) Pub. Date: May 7, 2020

(54) INTERACTION METHOD FOR INTERFERENCE COORDINATION INFORMATION, METHOD FOR REDUCING CROSS LINK INTERFERENCE, AND BASE STATION

(71) Applicant: NTT DOCOMO, INC., Tokyo (JP)

(72) Inventors: Nan MA, Beijing (CN); Zhi ZHANG, Beijing (CN); Tian TANG, Beijing (CN); Qixiang TANG, Beijing (CN); Wenbing LIAO, Beijing (CN); Zhibin HUO, Beijing (CN); Wei CAO, Beijing (CN); Shaozhen GUO, Beijing (CN); Xiaolin HOU, Beijing (CN); Lan CHEN, Beijing (CN)

(73) Assignee: NTT DOCOMO, INC., Tokyo (JP)

(21) Appl. No.: 16/609,504

(22) PCT Filed: May 3, 2018
(86) PCT No.: PCT/CN2018/085419

§ 371 Date: Oct. 30, 2019

(30) Foreign Application Priority Data
May 4, 2017 (CN) 201710308241.6

(51) Int. Cl. H04L 5/00; H04W 72/04; H04W 52/26

(52) U.S. Cl. CPC H04L 5/0032; H04W 52/262; H04W 72/044; H04W 72/0426

(57) ABSTRACT

An interaction method is presented for interference coordination information between base stations, a method for mitigating cross-link interference between base stations, and a base station using abovementioned methods. The interaction method for interference coordination information between base stations comprises: determining a predetermined beam setup of a base station; establishing a beam index indicating each beam in the predetermined beam setup and its corresponding status; and transmitting the beam index to other base stations. The method for mitigating cross-link interference between base stations comprises: receiving beam-associated interference coordination information from other base stations; determining, based on the interference coordination information, beam-associated interference status information; and adjusting, based on the interference status information, a power and/or a modulation coding scheme of each beam.

### TECHNICAL FIELD

The present application relates to the field of mobile communication, and more particularly, to an interaction method for interference coordination information between base stations, a method for mitigating cross-link interference between base stations, and a base station using said methods.

### BACKGROUND

With development of the mobile communication industry and growing demand for mobile data services, people are increasingly demanding on the speed and Quality of Service (Qos) of mobile communication. Currently, the fifth-generation mobile communication technology (5G) standards towards network diversification, broadbanding, integration, and intelligence are being developed and applied. Among various schemes for implementing mobile communication, the dynamic time division duplex (TDD) scheme realizes flexible service adaptability by means of dynamically changing the uplink and downlink transmission directions of each base station to adapt to changes in uplink and downlink traffic.

However, in the dynamic TDD scheme, since neighboring base stations may have different transmission directions (uplink and downlink) at any given time, new interference types are introduced, that is, downlink to uplink interference (interference from base station to base station), and uplink to downlink interference (interference from user equipment to user equipment). In particular, since the transmission power of the base station is usually much higher than the transmission power of the user equipment, and the path loss between the base stations may be very close to the path loss of the free space due to the heights of the base stations, the downlink-to-uplink cross-link interference (interference from base station to base station) will seriously impair the communication quality of the uplink.

### SUMMARY

In view of the above problems, the present application provides an interaction method for interference coordination information between base stations, a method for mitigating cross-link interference between base stations, and a base station using said methods.

According to an embodiment of the present application, there is provided an interaction method for interference coordination information between base stations, comprising: determining a predetermined beam setup of a base station; establishing a beam index indicating each beam in the predetermined beam setup and its corresponding status; and transmitting the beam index to other base stations.

According to another embodiment of the present application, there is provided a method for mitigating cross-link interference between base stations, comprising: receiving beam-associated interference coordination information from other base stations; determining, based on the interference coordination information, beam-associated interference status information; and adjusting, based on the interference status information, a power and/or a modulation coding mode of each beam.

According to yet another embodiment of the present application, there is provided a base station, comprising: an interference coordination information receiving unit configured to receive beam-associated interference coordination information from other base stations; an interference status information determining unit configured to determine, based on the interference coordination information, beam-associated interference status information; and an interference adjusting unit configured to adjust, based on the interference status information, a power and/or a modulation coding mode of each beam.

The interaction method for interference coordination information between base stations, the method for mitigating cross-link interference between base stations, and the base station using said methods provided according to the embodiments of the present application concurrently consider interference coordination and power limitation at a beam level by means of configuring beam-level interference coordination information between base stations, thus further improve spectral efficiency, resource utilization, and system throughput in comparison to considering interference coordination only at a physical resource block level.

### BRIEF DESCRIPTION OF THE DRAWINGS

Through the more detailed description of embodiments of the present application with reference to the accompanying drawings, the above and other objectives, features, and advantages of the present application will become more apparent. The drawings are to provide further understanding for the embodiments of the present application and constitute a portion of the specification, and are intended to interpret the present application together with the embodiments, rather than to limit the present application. In the drawings, the same reference sign generally refers to the same component or step.

FIG. 1 is a schematic diagram illustrating cross-link interference between base stations;

FIG. 2 is a flowchart illustrating an interaction method for interference coordination information between base stations according to an embodiment of the present application;

FIG. 3 is a schematic diagram illustrating a base station and its associated beams according to an embodiment of the present application;

FIGS. 4A and 4B are schematic diagrams illustrating a first exemplary format of a beam index according to an embodiment of the present application;

FIGS. 5A and 5B are diagrams illustrating a second exemplary format of a beam index according to an embodiment of the present application;

FIGS. 6A to 6C are diagrams illustrating a third exemplary format of a beam index according to an embodiment of the present application;

FIGS. 7A to 7C are diagrams illustrating a fourth exemplary format of a beam index according to an embodiment of the present application;

FIGS. 8A to 8C are diagrams illustrating a fifth exemplary format of a beam index according to an embodiment of the present application;

FIG. 9 is a flowchart outlining a method for mitigating cross-link interference between base stations according to an embodiment of the present application;

FIG. 10 is a flowchart further illustrating a first exemplary method for mitigating cross-link interference between base stations according to an embodiment of the present application;

FIG. 11 is a diagram illustrating a communication system to which a first exemplary method for mitigating cross-link interference between base stations according to an embodiment of the present application is applied;

FIG. 12 is a flowchart further illustrating a second exemplary method for mitigating cross-link interference between base stations according to an embodiment of the present application;

FIG. 13 is a diagram illustrating a communication system to which a second exemplary method for mitigating cross-link interference between base stations according to an embodiment of the present application is applied;

FIG. 14 is a flowchart further illustrating a third exemplary method for mitigating cross-link interference between base stations according to an embodiment of the present application;

FIG. 15 is a diagram illustrating a communication system to which a third exemplary method for mitigating cross-link interference between base stations according to an embodiment of the present application is applied;

FIG. 16 is a schematic diagram illustrating adjustment of a transmission power and a modulation coding mode by a method for mitigating cross-link interference between base stations according to an embodiment of the present application;

FIG. 17 is a block diagram illustrating a base station according to an embodiment of the present application; and

FIG. 18 is a block diagram illustrating an example of hardware configuration of a base station and a user equipment according to an embodiment of the present application.

### DETAILED DESCRIPTION OF THE EMBODIMENTS

To make the objectives, technical solutions, and advantages of the present application more clear, exemplary embodiments of the present application will be described in detail with reference to the accompanying drawings. Obviously, the described embodiments merely are only part of the embodiments of the present application, rather than all of the embodiments of the present application, it should be understood that the present application is not limited to the exemplary embodiments described herein. All other embodiments obtained by those skilled in the art without paying inventive efforts should fall into the protection scope of the present application.

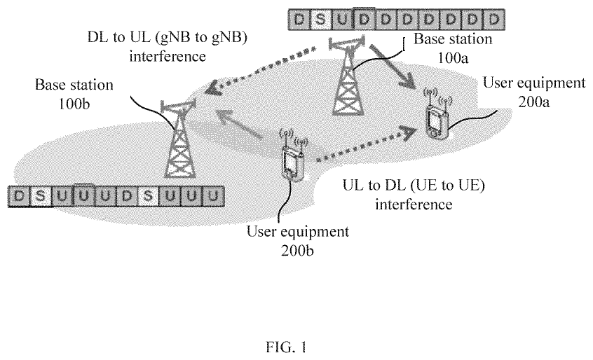

FIG. 1 is a schematic diagram outlining a communication system according to an embodiment of the present application. As shown in FIG. 1, at a specific moment t, the base station 100a performs downlink communication to transmit data to the user equipment 200a, meanwhile the base station 100b performs uplink communication to receive data from the user equipment 200b. At this time, there may be DL to UL (i.e., gNB to gNB) interference and UL to DL (i.e., UE to UE) interference. Since the transmission power of the base station 100a is usually much higher than the transmission power of the user equipment 200b, and the path loss between the base stations may be very close to the path loss of the free space due to the height of the base stations, the cross-link interference caused by the base station 100a on the base station 100b will seriously impair the communication quality of the base station 100b. Accordingly, the present application provides a method for mitigating cross-link interference between base stations. Specifically, in the method for mitigating cross-link interference between base stations according to the present application, interaction of interference coordination information between base stations is required, and the present application further provides an interaction method for interference coordination information between base stations, as well as interference coordination information between base stations at a beam level as configured to be applied to the interaction method. Hereinafter, detailed description will be provided with reference to the drawings.

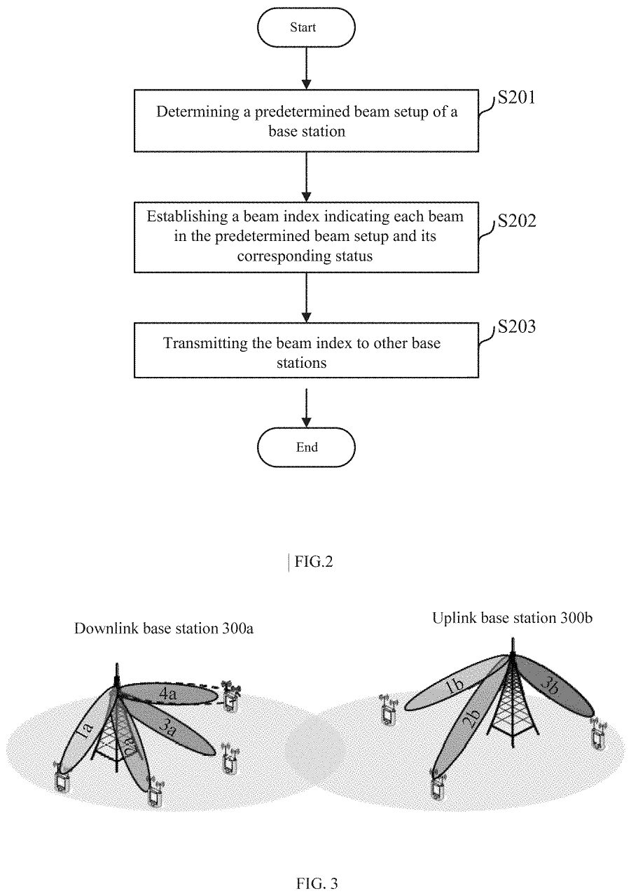

FIG. 2 is a flowchart illustrating an interaction method for interference coordination information between base stations according to an embodiment of the present application. As shown in FIG. 2, the interaction method for interference coordination information between base stations according to an embodiment of the present application comprises steps provided below.

In step S201, a predetermined beam setup of a base station is determined. In an embodiment of the present application, the base station first determines a beam setup available for uplink communication and downlink communication. Thereafter, the proceeding proceeds to step S202.

In step S202, a beam index indicating each beam in the predetermined beam setup and its corresponding status is established. In an embodiment of the present application, a corresponding status of each beam may be used to indicate whether each beam is used or a degree to which each beam is interfered. More specifically, as will be described in detail below with reference to the accompanying drawings, a corresponding status of each beam may indicate, with respect to a specific physical resource block, whether each beam is used or a degree to which each beam is interfered; a corresponding status of each beam may indicate an interference power corresponding to each beam, and/or an allowed interference power corresponding to each beam, and/or an allowed interference power of each beam corresponding to a different modulation coding mode; a corresponding status of each beam may indicate an interference power corresponding to each beam group that includes a predetermined number of beams, and/or an allowed interference power corresponding to each beam group, and/or an allowed interference of each beam group corresponding to a different modulation coding mode; a corresponding status of each beam may indicate an interference power corresponding to each sequence element in a predetermined beam index sequence formed by each beam, and/or an allowed interference power, and/or an allowed interference power of each sequence element corresponding to a different modulation coding mode, wherein each sequence element includes one or more beams. Thereafter, the proceeding proceeds to step S203.

In step S203, the beam index is transmitted to other base stations. In an embodiment of the present application, the beam index is a component part of interference coordination information between base stations. After transmitting its own interference coordination information between base stations and including the beam index and receiving interference coordination information between base stations and including the beam index from neighboring base stations, both the uplink base station and the downlink base station can determine current interference status information, and further adjusts, based on the interference status information, the transmission power and/or modulation coding method.

FIG. 3 is a schematic diagram illustrating a base station and its associated beams according to an embodiment of the present application. As shown in FIG. 3, the base station 300a performs downlink data communication with the user equipment through beams 1a to 4a, meanwhile the base station 300b performs uplink data communication with the user equipment through beams 1b to 3b. As previously mentioned, downlink data communication performed by the base station 300a through each of beams 1a to 4a may interfere with uplink data communication performed by the base station 300b through each of beams 1b to 3b. In order to mitigate cross-link interference between the base station 300a and the base station 300b, interaction of interference coordination information between base stations described above with reference to FIG. 2 needs to be performed at the base station 300a and the base station 300b.

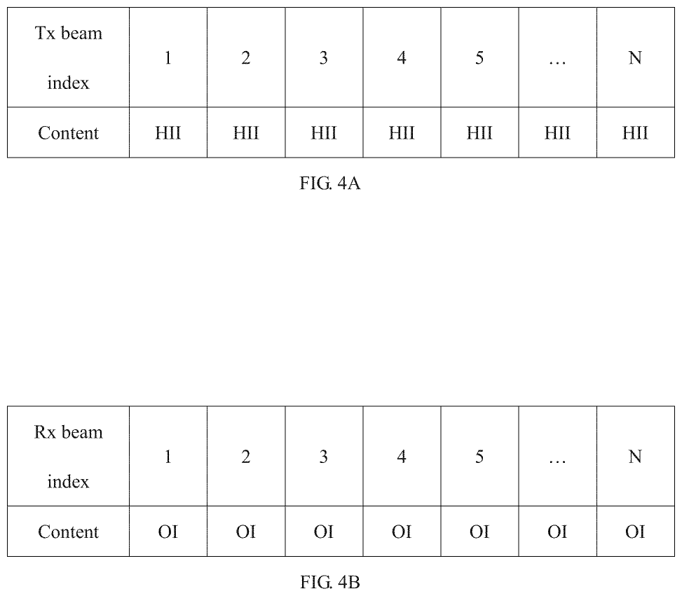

FIGS. 4A and 4B are schematic diagrams illustrating a first exemplary format of a beam index according to an embodiment of the present application. In the first exemplary format of a beam index in the interference coordination information between base stations as shown in FIGS. 4A and 4B, content of the beam index indicates whether each beam is used or a degree to which each beam is interfered. Specifically, for the transmit beam, content HII of the Tx beam index is used to indicate whether the beam is used. For example, when the value of HII is “1”, it indicates that the beam is used, and when the value of HII is “0”, it indicates that the beam is not used. For the receive beam, content OI of the Rx beam index is used to indicate a degree of interference received by the beam. For example, OI can be divided into three levels, indicating a low interference level, a medium interference levels, and a high interference level respectively.

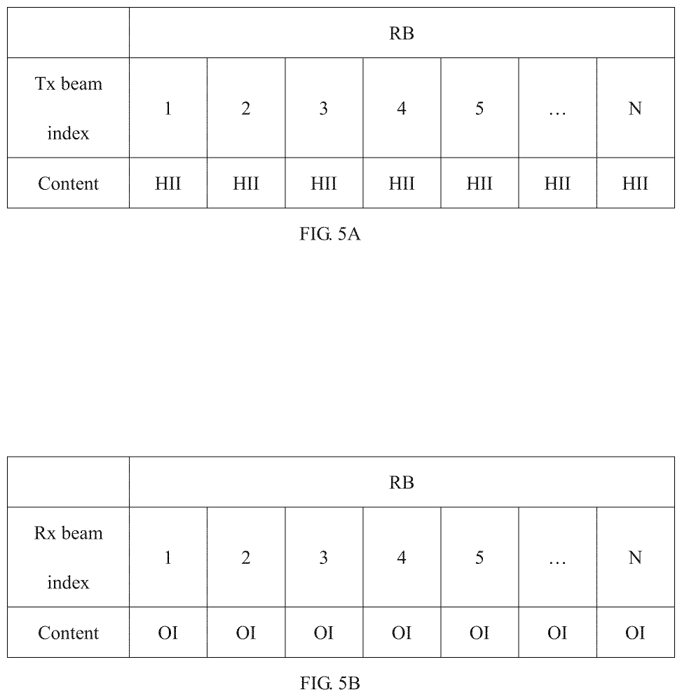

FIGS. 5A and 5B are diagrams illustrating a second exemplary format of a beam index according to an embodiment of the present application. In comparison to the first exemplary format of a beam index shown in FIGS. 4A and 4B, content of the beam index in the second exemplary format of a beam index according to an embodiment of the present application indicates, with respect to a specific physical resource block, whether each beam is used or a degree to which each beam is interfered. The meanings of HII and OI in the beam index in the second exemplary format of the beam index according to the embodiment of the present application are the same as those in the first exemplary format, and repetitive description thereof will be omitted herein.

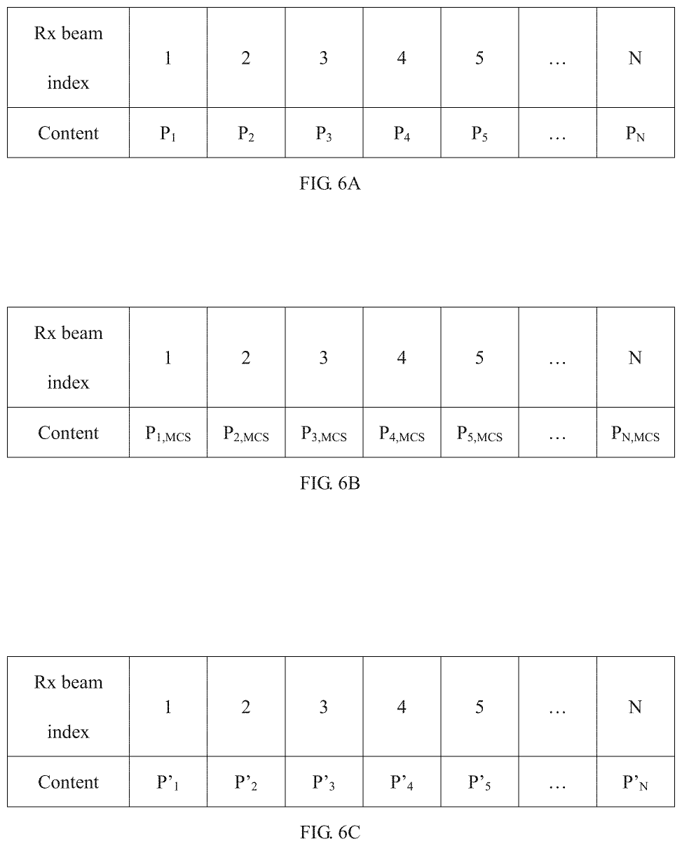

FIGS. 6A to 6C are diagrams illustrating a third exemplary format of a beam index according to an embodiment of the present application. Different than the first and second exemplary formats described with reference to FIGS. 4A to 5B, content of the beam index in the third exemplary format of the beam index according to an embodiment of the present application is used to indicate information related to a quantized interference power. For example, contents P₁ to P_{N} of the beam index in FIG. 6A indicate a quantized power corresponding to the allowed interference power of each beam; contents P_{1,MCS} to P_{N,MCS} of the beam index in FIG. 6B indicate a quantized power of the allowed interference power of each beam corresponding to a different modulation coding mode (MCS); contents P′₁ to P′_{N} of the beam index in FIG. 6C indicate a quantized power of each beam corresponding to the interference power.

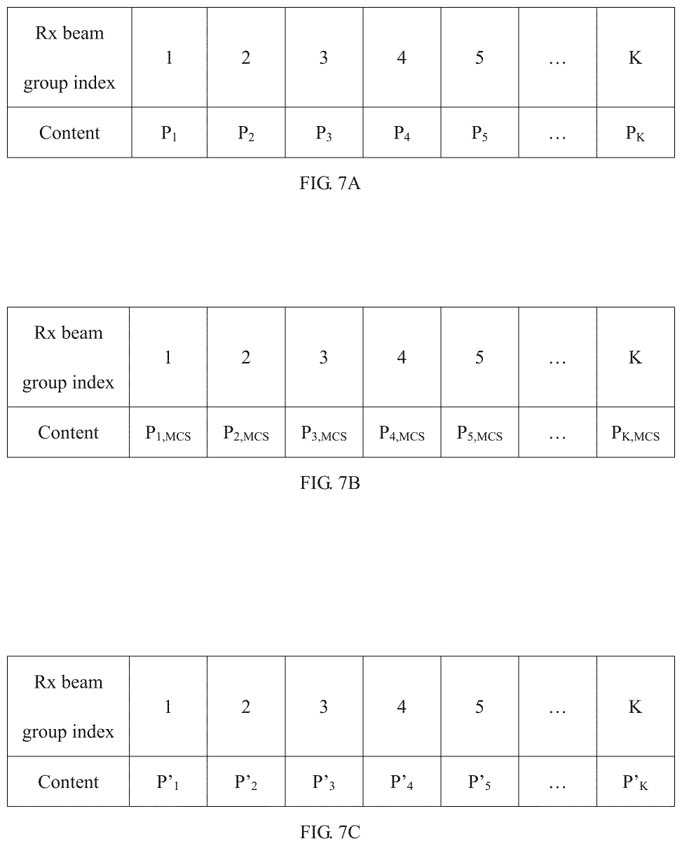

FIGS. 7A to 7C are diagrams illustrating a fourth exemplary format of a beam index according to an embodiment of the present application. The beam index in the fourth exemplary format of the beam index according to an embodiment of the present application further considers the case of performing beam group indexing in a massive MIMO application scenario on the basis of the third exemplary format. Each beam group in FIGS. 7A to 7C may include a plurality of beams, for example, a beam group 1 may include beams 0 to N₁, a beam group 2 may include beams N₁+1 to N₂, and so on, and so forth, a beam group K may include beams N_{K-1}+1 to N_{K}. Further, contents P₁ to P_{K} of the beam index in FIG. 7A indicate a quantized power of the allowed corresponding to each beam group; contents P_{1,MCS} to P_{K,MCS} of the beam index in FIG. 7B indicate a quantized power of the allowed interference power of each beam group corresponding to a different modulation coding scheme (MCS); contents P′₁ to P′_{K} of the beam index in FIG. 7C indicate a quantized power of each beam group corresponding to the interference power.

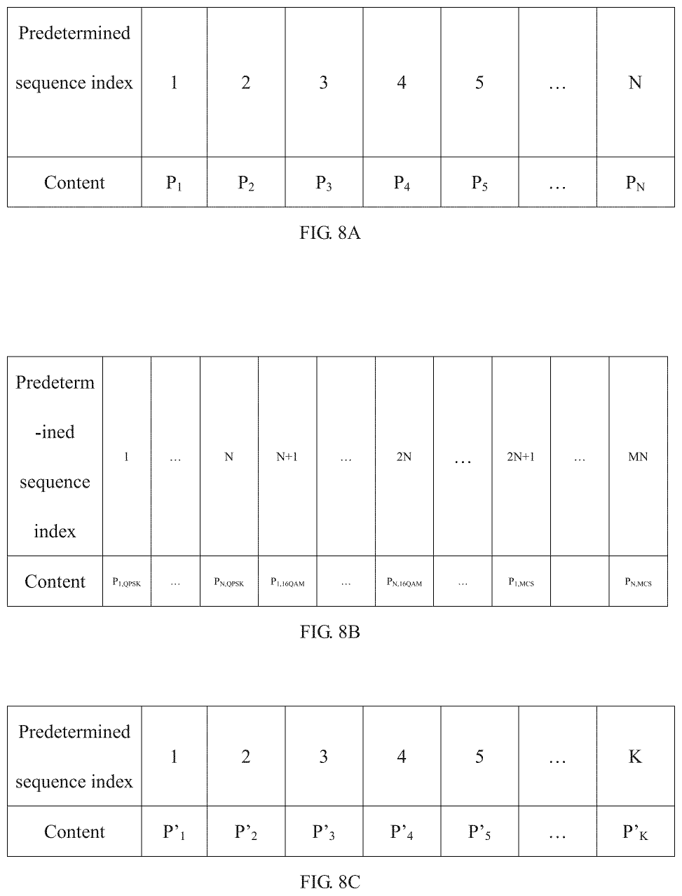

FIGS. 8A to 8C are diagrams illustrating a fifth exemplary format of a beam index according to an embodiment of the present application. In order to further reduce the signaling overhead of user interaction information between base stations, a beam indexing mode according to a predetermined beam index sequence may be considered, wherein each sequence element includes one or more beams. Such predetermined beam index sequence is known to all base stations, so the base station receiving the beam index can obtain information about the quantized interference power of the corresponding beam or beam group based on the predetermined index sequence. For example, contents P₁ to P_{N} of the beam index in FIG. 8A indicate a quantized power corresponding to the allowed interference power of each sequence element in the predetermined beam index sequence; contents P_{1,QPSK} to P_{N,MCS} of the beam index in FIG. 8B indicate a quantized power of the allowed interference power of each sequence element in the predetermined beam index sequence corresponding to a different modulation coding scheme (MCS); contents P′₁ to P′_{K} of the beam index in FIG. 8C indicate a quantized power corresponding to the interference power of each sequence element in the predetermined beam index sequence.

The beam index and its interaction method according to the embodiment of the present application have been described above with reference to FIGS. 2 to 8C. Hereinafter, a method for mitigating cross-link interference between base stations using the beam index will be described with further reference to the accompanying drawings.

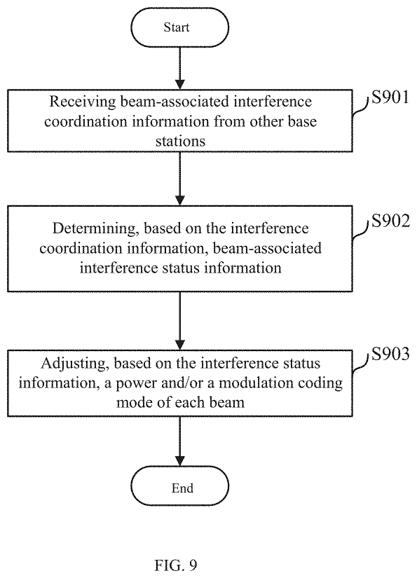

FIG. 9 is a flowchart outlining a method for mitigating cross-link interference between base stations according to an embodiment of the present application. As shown in FIG. 9, the method for mitigating cross-link interference between base stations according to an embodiment of the present application comprises steps provided below.

In step S901, beam-associated interference coordination information from other base stations is received. In an embodiment of the present application, as will be described in detail below, the beam-associated interference coordination information includes one or more of: beam index information of base stations, physical resource block configuration information, allowed interference power information corresponding to each beam (with respect to the uplink base station), and interference power information corresponding to each beam (with respect to the downlink base station). The beam index information of the base station may adopt the first to fifth beam index formats as described above with reference to FIGS. 4A to 8C. Thereafter, the processing proceeds to step S902.

In step S902, beam-associated interference status information is determined based on the interference coordination information. In an embodiment of the present application, as will be described in detail below, the interference status information includes one or more of: an allowed interference power of each beam of an uplink base station in a different modulation coding mode with respect to a downlink base station; an interference power caused by each beam of the downlink base station on each beam of the uplink base station; a total interference power caused by each beam of the downlink base station on the uplink base station; and a total interference power caused by the downlink base station on each beam of the uplink base station. Thereafter, the processing proceeds to step S903.

In step S903, a power and/or a modulation coding mode of each beam is adjusted based on the interference status information. In an embodiment of the present application, as will be described in detail below, the downlink base station may adjust the power of each beam based on the interference status information, the uplink base station may modulate the coding mode based on the interference status information, or the uplink base station and the downlink base station may perform coordinated adjustment based on the interference status information.

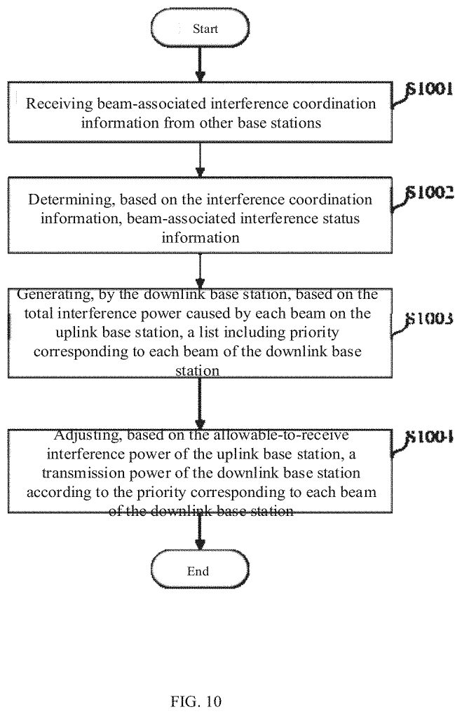

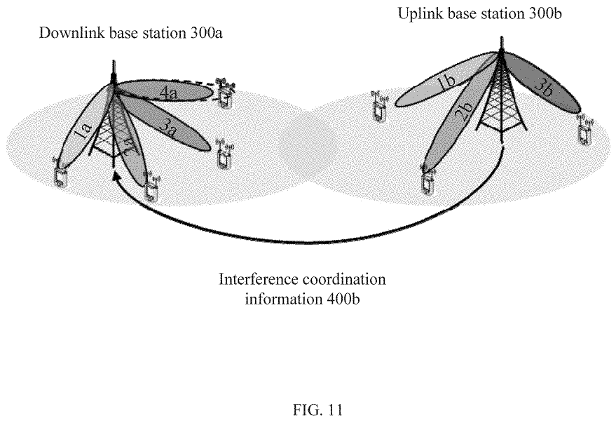

FIG. 10 is a flowchart further illustrating a first exemplary method for mitigating cross-link interference between base stations according to an embodiment of the present application; FIG. 11 is a diagram illustrating a communication system to which a first exemplary method for mitigating cross-link interference between base stations according to an embodiment of the present application is applied. The first exemplary method as shown in FIGS. 10 and 11 is performed by a downlink base station.

In step S1001, beam-associated interference coordination information from other base stations is received. In the first exemplary method, referring to FIG. 11, the downlink base station 300a receives interference coordination information 400b from the uplink base station 300b, the interference coordination information 400b may include beam index information of the uplink base station 300b, physical resource block configuration information, allowed interference power information corresponding to each beam,. Thereafter, the processing proceeds to step S1002.

In step S1002, beam-associated interference status information is determined based on the interference coordination information. In the first exemplary method, the beam-associated interference status information includes: (1) an allowed interference power of each beam of an uplink base station in a given modulation coding mode with respect to a downlink base station; (2) an interference power caused by each beam of the downlink base station on each beam of the uplink base station; (3) a total interference power caused by each beam of the downlink base station on the uplink base station.

Specifically, during calculation of the beam-related interference status information, the following parameters are preset:
j: Index of target interfered base station
i: Index of interfering base station
j′: Index of other interfering base stations other than target interfered base station
k: Index of target receive beam
k*: Index of other receive beams except the target receive beam
k′: Index of transmit beam

(1) The allowed interference of each beam of the uplink base station in a given modulation coding mode with respect to the downlink base station is calculated by Expressions (1) to (5).

$${SINR}_{jk}^{VUE} = {2}^{\frac{{R}_{jk}^{VUE}}{B}} - 1 \qquad Expression ( 1 )$$

where SINRⱼₖ^{VUE} represents a signal and interference to noise ratio (SINR) requirement of the user of the base station j on the k-th beam, Rⱼₖ^{VUE} represents a transmission rate requirement of the user of the base station j on the k-th beam, and B represents a transmission bandwidth.

Pⱼₖ^{VUE-VBS}=∥Gⱼₖ^{VUE}Hⱼₖ^{VUE-VBS}∥²Pⱼₖ^{VUE} Expression (2)

where Pⱼₖ^{VUE-VBS} represents a reception power of the user of the base station j at the k-th beam, Gⱼₖ^{VUE} represents an equalization matrix of the user of the base station j at the k-th beam, Hⱼₖ^{VUE-VBS} represents a channel of the user of the base station j on the k-th beam, and Pⱼₖ^{VUE} represents a transmission power of the user of the base station j on the k-th beam.

$$Expression ( 3 )$$

$$\begin{matrix}{SINR}_{jk}^{VUE} = \frac{{P}_{jk}^{VUE - VBS}}{{\sum }_{i} {\sum }_{{k}^{′}} {I}_{{ijk}^{′} k}^{IBS - VBS} + {\sum }_{{j}^{′}} {\sum }_{k} {I}_{{j}^{′} {jk}^{′} k}^{VUE - VBS} + {\sum }_{{k}^{*}} {I}_{{jjk}^{′} {k}^{*}}^{VUE - VBS} + {N}_{0}} \\ \approx \frac{{P}_{jk}^{VUE - VBS}}{{\sum }_{i} {\sum }_{{k}^{′}} {I}_{{ijk}^{′} k}^{IBS - VBS} + {N}_{0}}\end{matrix}$$

where I_{ijk′k}^{IBS-VBS} represents an interference power from the k′-th beam of the base station i to the k-th beam of the base station j, I_{j′jk′k}^{VUE-VBS} represents an interference power from the k′-th beam from the base station j′ to the k-th beam of the base station j, I_{jjk′k*}^{VUE-VBS} represents an interference power of the k*-th beam from the base station j to the k-th beam of the base station j, N₀ represents a noise power.

$${\sum }_{i} {\sum }_{{k}^{′}} {I}_{{ijk}^{′} k}^{IBS - VBS} = \frac{{P}_{jk}^{VUE - VBS}}{{SINR}_{jk}^{VUE}} - {N}_{0} \qquad Expression ( 4 )$$

where

$${\sum }_{i} {\sum }_{{k}^{′}} {I}_{{ijk}^{′} k}^{IBS - VBS}$$

represents a total allowed interference power of the k-th beam of the base station j.

$${I}_{ijk}^{allow} = {\sum }_{{k}^{′}} {I}_{{ijk}^{′} k}^{allow} = \frac{{RSRP}_{ij}}{{\sum }_{i = 1}^{I} {RSRP}_{ij}} {\sum }_{i} {\sum }_{{k}^{′}} {I}_{{ijk}^{′} k}^{IBS - VBS} \qquad Expression ( 5 )$$

where Iᵢⱼₖ^{allow} represents a total allowed interference power of the k-th beam of the base station j with respect to the base station i, I_{ijk′k}^{allow} represents an interference power allowed on the k-th beam of the base station j from the k′-th beam of the base station i, RSRPᵢⱼ represents a received signal reference power from the base station i to the base station j.

(2) The interference power on each beam of the uplink base station from each beam of the downlink base station is calculated by Expression (6).

P_{k′k}=P_{ik′}^{IBS-IUE}81 Gⱼₖ^{VUE}H_{ijkk′}^{IBS-VBS}W_{ik′}^{IUE}∥² Expression (6)

where P_{k′k} represents an interference power on the k-th beam of the base station j from the k′-th beam of the base station i, P_{ik′}^{IBS-IUE} represents a transmission power on the k′-th beam of the base station i, Gⱼₖ^{VUE} represents am equalization matrix of the user of the base station j on the k-th beam, H_{ijkk′}^{IBS-VBS} represents a channel matrix of the k′-th beam of base station i to the k-th beam of the base station j, W_{ik′}^{IUE} represents a transmit precoding matrix of base station i on the k′-th beam.

(3) The total interference power on the uplink base station from each beam of the downlink base station is calculated by Expression (7-1):

$${P}_{{k}^{′}} = {\sum }_{k = 1}^{K} {P}_{{k}^{′} k} \qquad Expression ( 7 \text{-} 1 )$$

where P_{k′} represents a total interference power from the k′-th beam of the base station i to the base station j, P_{k′k} represents an interference power from the k′-th beam of the base station i to the k-th beam of the base station j.

After the interference status information is determined in step S1002, the processing proceeds to step S1003.

In step S1003, the downlink base station generates, based on the total interference power caused by each beam of the downlink base station on the uplink base station, a list including priority corresponding to each beam of the downlink base station. In this first exemplary method, the downlink base station 300a assigns a higher priority to the beam having a lower total interference power with respect to the uplink base station 300b. Thereafter, the processing proceeds to step S1004.

In step S1004, based on the allowed interference power of the uplink base station, a transmission power of beam of the downlink base station is adjusted according to the priority corresponding to each beam of the downlink base station. In the first exemplary method, the downlink base station 300a adjusts the transmission power of the beam having the lowest priority according to Expression (8).

$${P}_{i {\tilde{k}}^{′}}^{IBS - IUE} = {min}_{k} \{ \frac{{I}_{ijk}^{allow} - {{\sum }_{{k}^{′} = 1 , {k}^{′} \neq {\tilde{k}}^{′}}}^{{K}^{′}} {P}_{{k}^{′} , k}}{‖ {G}_{jk}^{VUE} {H}_{ijk {\tilde{k}}^{′}}^{IBS - VBS} {W}_{i {\tilde{k}}^{′}}^{IUE} ‖} \} \qquad Expression ( 8 )$$

where P_{i\tilde{k}′}^{IBS-IUE} represents transmission power of the base station i on the k-th beam, Iᵢⱼₖ^{allow} represents a total allowed interference power of the k-th beam of the base station j with respect to the base station i, P_{k′,k} represents interference power from the k′-th beam of the base station i on the k-th of the base station j, Gⱼₖ^{VUE} represents an equalization matrix of the user of the base station j on the k-th beam, H_{ijk\tilde{k}′}^{IBS-VBS} represents a channel matrix from the k′-th beam of the base station i to the k-th beam of the base station j, W_{i\tilde{k}′}^{IUE} represents a transmit precoding matrix of the base station i on the k′-th beam.

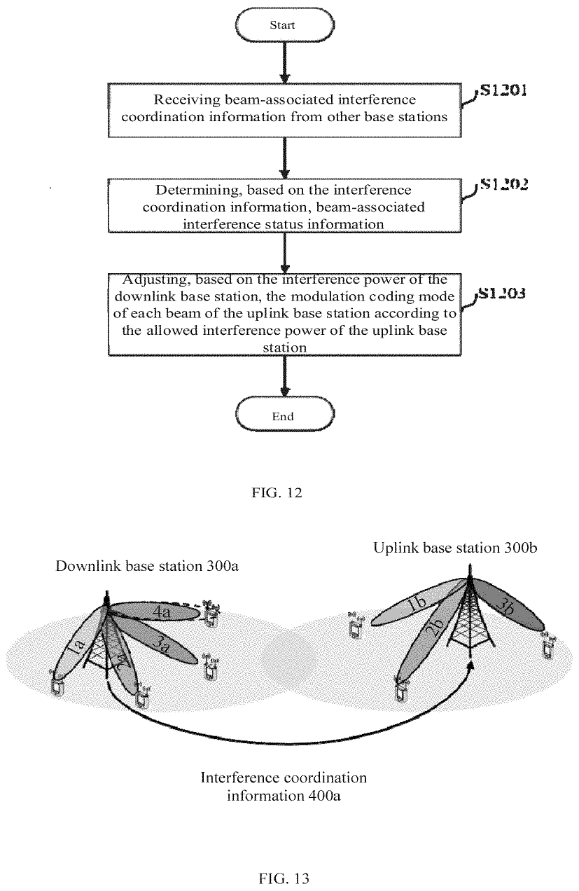

FIG. 12 is a flowchart further illustrating a second exemplary method for mitigating cross-link interference between base stations according to an embodiment of the present application; FIG. 13 is a diagram illustrating a communication system to which a second exemplary method for mitigating cross-link interference between base stations according to an embodiment of the present application is applied. The second exemplary method as shown in FIGS. 12 and 13 is performed by an uplink base station.

In step S1201 beam-associated interference coordination information from other base stations is received. In the second exemplary method, as shown in FIG. 13, the uplink base station 300b receives interference coordination information 400a from the downlink base station 300a, and the interference coordination information 400a may include beam index information of the downlink base station 300a, physical resource block configuration information, interference power information of each beam with respect to the uplink base station 300b. Thereafter, the processing proceeds to step S1202.

In step S1202, beam-associated interference status information is determined based on the interference coordination information. In the second exemplary method, the beam-associated interference status information includes: (1) an allowed interference power of each beam of an uplink base station in a different modulation coding mode with respect to a downlink base station; (2) an interference power caused by each beam of the downlink base station on each beam of the uplink base station; (4) a total interference power caused by the downlink base station on each beam of the uplink base station.

(4) A total interference power caused by the downlink base station on each beam of the uplink base station is calculated by Expression (7-2):

$${P}_{k} = {\sum }_{{k}^{′} = 1}^{{K}^{″}} {P}_{{k}^{′} k} \qquad Expression ( 7 \text{-} 2 )$$

where Pₖ represents a total interference power from the base station i to the k-th beam of the base station j, P_{k′k} represents an interference power from the k′-th beam of the base station i to the k-th beam of the base station j.

After the interference status information is determined in step S1202, the processing proceeds to step S1203.

In step S1203, based on the interference power of the downlink base station, the modulation coding mode of each beam of the uplink base station is adjusted according to the allowable interference power of the uplink base station. In the second exemplary method, the uplink base station 300b can adjust the modulation coding mode of its beam, and select a lower order modulation coding mode for the beam with larger interference.

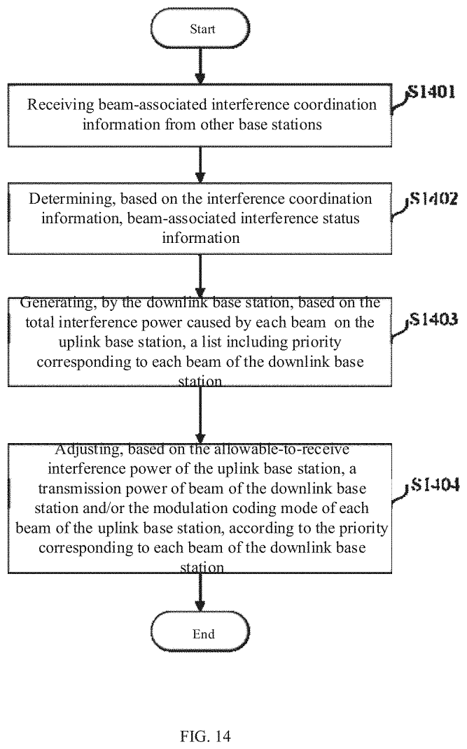

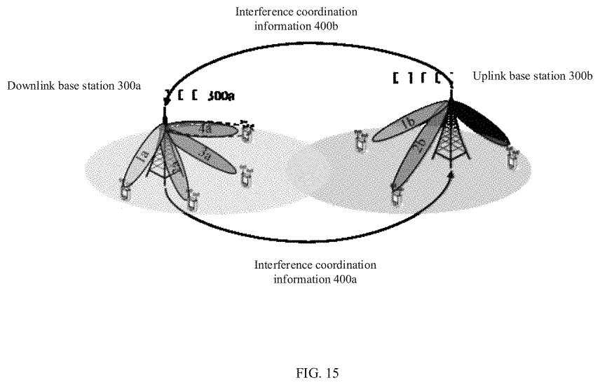

FIG. 14 is a flowchart further illustrating a third exemplary method for mitigating cross-link interference between base stations according to an embodiment of the present application; FIG. 15 is a diagram illustrating a communication system to which a third exemplary method for mitigating cross-link interference between base stations according to an embodiment of the present application is applied. The third exemplary method as shown in FIGS. 14 and 15 is performed interactively by an uplink base station and a downlink base station.

In step S1401, beam-associated interference coordination information is received from other base stations. In the third exemplary method, referring to FIG. 15, the downlink base station 300a receives the interference coordination information 400b from the uplink base station 300b, and the interference coordination information 400b may include beam index information of the uplink base station 300b, physical resource block configuration information, allowed-to receive interference power information corresponding to each beam. Meanwhile, the uplink base station 300b receives interference coordination information 400a from the downlink base station 300a, interference coordination information 400a may include beam index information of the downlink base station 300a, physical resource block configuration information, and interference power information of each beam with respect to the uplink base station 300b. Thereafter, the processing proceeds to step S1402.

In step S1402, beam-associated interference status information beams is determined based on the interference coordination information. In this third exemplary method, the beam-related interference status information is calculated by Expressions (1) to (7-2) described above with reference to FIGS. 10 to 13. Thereafter, the processing proceeds to step S1403.

In step S1403, the downlink base station generates, based on the total interference power caused by each beam of the downlink base station on the uplink base station, a list including priority corresponding to each beam of the downlink base station. Like the first exemplary method, the downlink base station 300a assigns a higher priority to the beam having a lower total interference power with respect to the uplink base station 300b. Thereafter, the processing proceeds to step S1404.

In step S1404, based on the allowed interference power of the uplink base station, a transmission power of each beam of the downlink base station and/or a modulation coding mode of each beam of the uplink base station is adjusted according to the priority corresponding to each beam of the downlink base station. In the third exemplary method, the manner in which the downlink base station 300a adjusts the transmission power of the beam of the downlink base station and the uplink base station 300b adjusts the modulation coding mode of the beam of the uplink base station is the same as steps S1004 and S1203 described above with reference to FIGS. 10 and 12 respectively.

Further, in the third exemplary method, a tradeoff may be performed between adjusting the transmission power of the beam of the downlink base station and adjusting the modulation coding mode of the beam of the uplink base station according to the needs of actual communication, so as to simultaneously satisfy communication needs of the respective base stations and its user equipment.

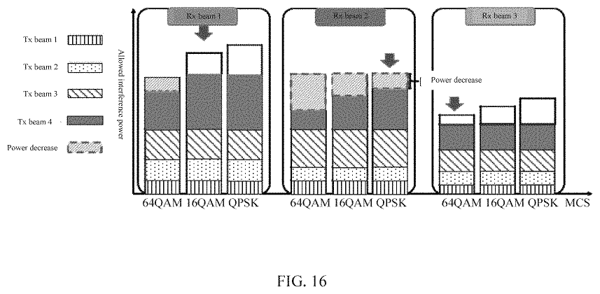

FIG. 16 is a schematic diagram illustrating adjustment of a transmission power and a modulation coding mode by a method for mitigating cross-link interference between base stations according to an embodiment of the present application.

As shown in FIG. 16, for Rx beam 1, when the 64 QAM modulation coding mode is adopted, the total interference power from Tx beams 1 to 4 of the downlink base station to Rx beam 1 is greater than the interference power allowed on Rx beam 1. At this time, a feasible way is to adjust the modulation coding mode of Rx beam 1. As shown in FIG. 16, when Rx beam 1 adopts the 16 QAM and QPSK modulation coding modes, requirement of the allowed-to-receive interference power can be satisfied. Alternatively, the transmission power of Tx beam 4 (having the largest interference power on Rx beam 1) of the downlink base station can also be reduced, thereby reducing the total interference power on Rx beam 1 so as to meet the requirement of the allowed the allowed interference power.

For Rx beam 2, the 16 QAM and QPSK modulation coding cannot be achieved by adopting 64 QAM, 16 QAM, and QPSK modulation coding modes. In this case, it is necessary to reduce the transmission power of Tx beam 4 (having the maximum interference power on Rx beam 1) of the downlink base station, thereby reducing the total interference power on Rx beam 1 so as to meet the requirement of the allowed the allowed interference power.

Similarly, for Rx Beam 3, in the case of adopting 64 QAM, 16 QAM, and QPSK modulation coding, so as to meet the requirement of the allowed the allowed interference power can be always satisfied, thereby there is no need to reduce the transmission power of Tx beam of the downlink base station.

The method for mitigating cross-link interference between base stations according to the embodiment of the present application is described above with reference to the accompanying drawings, next, a base station according to an embodiment of the present that adopts the method for mitigating cross-link interference between base stations according to the embodiment of the present application will be further described below with reference to the accompanying drawings.

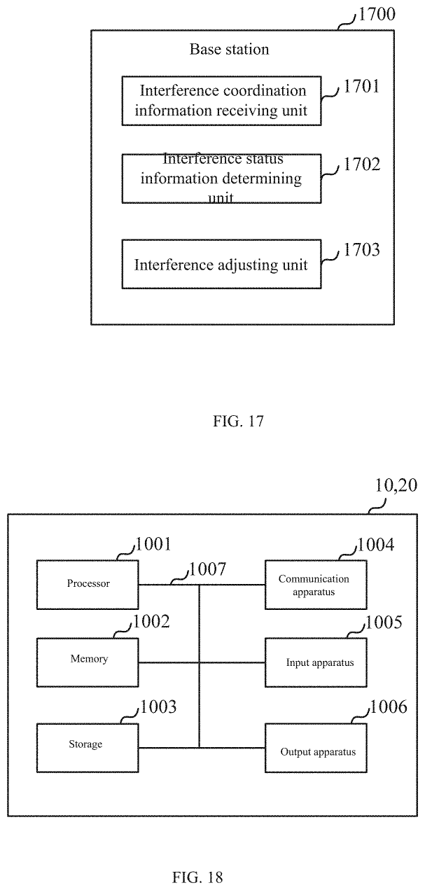

FIG. 17 is a block diagram illustrating a base station according to an embodiment of the present application. As shown in FIG. 17, the base station 1700 according to the embodiment of the present application comprises an interference coordination information receiving unit 1701, an interference status information determining unit 1702, and an interference adjusting unit 1703.

Specifically, the interference coordination information receiving unit 1701 is configured to receive beam-associated interference coordination information from other base stations. The interference status information determining unit 1702 is configured to determine, based on the interference coordination information, beam-associated interference status information. The interference adjusting unit 1703 is configured to adjust, based on the interference status information, a power and/or a modulation coding mode of each beam. The interference coordination information received by the interference coordination information receiving unit 1701 includes one or more of: beam index information of base stations, physical resource block configuration information, allowed interference power information corresponding to each beam, and interference power information corresponding to each beam. The interference status information determined by the interference status information determining unit 1702 includes one or more of: an allowed interference power of each beam of an uplink base station in a different modulation coding mode with respect to a downlink base station; an interference power caused by each beam of the downlink base station on each beam of the uplink base station; a total interference power caused by each beam of the downlink base station on the uplink base station; and a total interference power caused by the downlink base station on each beam of the uplink base station.

Further, when being configured in the downlink base station, the interference adjusting unit 1703 generates, based on the total interference power caused by each beam on the uplink base station, a list including priority corresponding to each beam of the downlink base station; and adjusts, based on the allowed interference power of the uplink base station, a transmission power of each beam according to the priority corresponding to each beam. When being configured in the uplink base station, the interference adjusting unit 1703 adjusts, based on the interference power of the downlink base station, the modulation coding mode of each beam according to the allowed interference power of the uplink base station

The block diagrams used in the above description of the foregoing embodiment illustrate blocks of functional units. The functional blocks (constituent elements) are realized by any combination of hardware and/or software. In addition, means for realizing each functional block is not specifically limited. That is, each functional block may be realized by one apparatus in which the functional blocks are combined physically and/or logically or may be realized by two or more apparatuses that are physically and/or logically separated by connecting the plurality of apparatuses directly and/or indirectly (for example, in a wired and/or wireless manner).

For example, the base station and the user equipment according to the embodiment of the present application may function as a computer that performs processes of a wireless communication method according to the present application. FIG. 18 is a block diagram illustrating an example of a hardware configuration of the base station and the user equipment according to an embodiment of the present application. The base station 10 and the user equipment 20 described above may be physically configured as a computer apparatus that includes a processor 1001, a memory 1002, a storage 1003, a communication apparatus 1004, an input apparatus 1005, an output apparatus 1006, and a bus 1007 or the like.

In addition, in the following description, a term “apparatus” can be replaced with a circuit, a device, a unit, or the like. The hardware configuration of the base station 10 and the user equipment 20 may be configured to include one apparatus or a plurality of apparatuses illustrated in the drawing or may be configured not to include some of the apparatuses.

For example, the processor 1001 only illustrates one, but may be a plurality of processors. In addition, the processing may be performed by one processor, or may be performed by one or more processors simultaneously, sequentially, or by other methods. Additionally, the processor 1001 can be installed by more than one chip.

The functions of the base station 10 and the user equipment 20 are realized by the following manners: reading predetermined software (program) on hardware such as the processor 1001 or the memory 1002 so that the processor 1001 can perform an arithmetic operation and by controlling communication by the communication apparatus 1004 and reading and/or writing of data in the memory 1002 and the storage 1003.

For example, the processor 1001 controls the entire computer by operating an operating system. The processor 1001 may be also configured as a central processing unit (CPU) that includes an interface with a peripheral apparatus, a control apparatus, an arithmetic apparatus, a register, and the like. For example, the receiving control unit 103 and the retransmission control unit 203 may be realized by the processor 1001.

In addition, the processor 1001 reads a program (program codes), a software module, data and so on from the storage 1003 and/or the communication apparatus 1004 to the memory 1002 and performs various processes according to the program, the software module, or the data. As the program, a program causing a computer to perform at least some of the operations described in the foregoing embodiment is used. For example, the retransmission control unit 203 of the user equipment 20 may be stored in the memory 1002 and realized by a control program that is operated by the processor 1001. Another functional block may be similarly realized. The memory 1002 is a computer-readable recording medium and may be configured by at least one of, for example, a read-only memory (ROM), an erasable programmable ROM (EPROM), an electrically erasable programmable ROM (EEPROM), and a random access memory (RAM), and other proper storage mediums. The memory 1002 may also be referred to as a register, a cache, a main memory (main storage apparatus), or the like. The memory 1002 can store a program (program codes), a software module, or the like which can be executed to perform an information transmission method and a wireless communication method according to an embodiment of the present application.

The storage 1003 is a computer-readable recording medium and may be configured by at least one of, for example, a flexible disk, a floppy (registered trademark) disk, a magneto-optical disk (for example, a Compact Disc ROM (CD-ROM), etc.), a digital versatile disc, a Blu-ray (registered trademark) disc, a removable disk, a hard disk drive, a smart card, a flash memory (for example, a card, a stick, or a key drive), a magnetic strip, a database, a server, and another appropriate medium. The storage 1003 may be also referred to as an auxiliary storage apparatus.

The communication apparatus 1004 is hardware (a transmission and reception device) that performs communication between computers via a wired and/or wireless network and is also referred to as, for example, a network device, a network controller, a network card, or a communication module. The communication apparatus 1004 may include a high frequency switch, a duplexer, a filter, a frequency synthesizer, etc., in order to implement, for example, Frequency Division Duplex (FDD) and/or Time Division Duplex (TDD). For example, the transmitting unit 101, the receiving unit 102, the receiving unit 201, and the transmitting unit 202 described above may be realized by the communication apparatus 1004.

The input apparatus 1005 is an input device (for example, a keyboard, a mouse, a microphone, a switch, a button, or a sensor) that receives an input from the outside. The output apparatus 1006 is an output device (for example, a display, a speaker, or an LED lamp) that performs an output to the outside. The input apparatus 1005 and the output apparatus 1006 may be configured to be integrated (for example, a touch panel).

In addition, the apparatuses such as the processor 1001 and the memory 1002 are connected to the bus 1007 for communicating information. The bus 1007 may be configured as a single bus or may be configured by different buses between the apparatuses.

In addition, the base station 10 and the user equipment 20 may be configured to include hardware such as a microprocessor, a digital signal processor (DSP), an application specific integrated circuit (ASIC), a programmable logic device (PLD), a field programmable gate array (FPGA), or some or all of the functional blocks may be realized by the hardware. For example, the processor 1001 may be implemented in at least one of the hardware.

The interaction method for interference coordination information between base stations, the method for mitigating cross-link interference between base stations, and the base station using said methods provided according to the embodiments of the present application have been described in the above with reference to FIGS. 1 to 18, interference coordination and power limitation at a beam level are concurrently considered by means of configuring beam-level interference coordination information between base stations, thus spectral efficiency, resource utilization, and system throughput are further improved in comparison to considering interference coordination only at a physical resource block level.

In addition, the terms described in this specification and/or terms necessary to understand this specification may be replaced with terms that have same or similar meanings. For example, a channel and/or a symbol may be a signal (signaling). In addition, a signal may be also a message. A reference signal may also be simply referred to as RS (Reference Signal), and may also be called pilot, pilot signal, etc. according to applicable standards. In addition, a component carrier (CC) may also be referred to as a cell, a frequency carrier, a carrier frequency, or the like.

In addition, the information, the parameter, or the like described in this specification may be represented by an absolute value, may be also represented by a relative value from a predetermined value, or may be also represented by another piece of corresponding information. For example, a radio resource may be indicated using an index. Further, the formula or the like using these parameters may be different from those explicitly disclosed in this specification.

The names used for the above-described parameters are not limited in any respect. For example, various channels (Physical Uplink Control Channel (PUCCH), Physical Downlink Control Channel (PDCCH), or the like) and information elements can be identified with any appropriate names, thus various names allocated to the various channels and information elements are not limited in any respect.

The information, the signal, and the like described in this specification may be represented using any of various technologies. For example, the data, the order, the command, the information, the signal, the bit, the symbol, the chip, and the like mentioned throughout the foregoing description may be represented by a voltage, a current, an electromagnetic wave, a magnetic field, or a magnetic particle, an optical field or a photon, or any combination thereof.

In addition, information or the like can be output from a higher layer to a lower layer and/or from a lower layer to a higher layer). Information or the like may be input or output via a plurality of network nodes.

The input or output information, signal, or the like may be stored in a specific location (for example, a memory) or may be managed with a management table. The input or output information, signal, or the like may be overwritten, updated, or edited. The output information, signal, or the like may be deleted. The input information, signal or the like may be transmitted to another apparatus.

The notification of information is not limited to the aspects/embodiments described in this specification and may be performed in accordance with other methods. For example, the notification of information may be performed with physical layer signaling (for example, downlink control information (DCI), uplink control information (UCI)), higher layer signaling (for example, radio resource control (RRC) signaling, broadcast information (master information block (MIB), a system information block (SIB) or the like), medium access control (MAC) signaling, or another signal, or a combination thereof

Further, the physical layer signaling may be referred to as L1/L2 (Layer 1/Layer 2) control information (L1/L2 control signal), L1 control information (L1 control signal), and the like. In addition, The RRC signaling may be referred to as an RRC message or may be, for example, an RRC connection setup message or an RRC connection reconfiguration message. Furthermore, the MAC signaling can be notified, for example, by a MAC Control Unit (MAC CE).

In addition, notification of predetermined information (for example, notification of “ACK”, “NACK”) is not limited to being performed explicitly and may be performed implicitly (for example, the notification of the predetermined information is not performed, the notification of other information is performed).

Determination may be made based on a value (0 or 1) represented by 1 bit, may be made based on a true or false value (boolean value) represented by true or false, or may be made based on comparison with a numerical value (for example, comparison with a predetermined value).

Regardless of the fact that software is referred to as software, firmware, middleware, a microcode, or a hardware description language or is referred to as another name, the software is broadly interpreted to mean a command, a command set, a code, a code segment, a program code, a program, a sub-program, a software module, an application, a software application, a software package, a routine, a subroutine, an object, an executable file, an execution thread, a procedure, a function, or the like.

In addition, software, a command, information, or the like may be transmitted or received via a transmission medium. For example, when software is transmitted from a website, a server, or another remote source using a wired technology such as a coaxial cable, an optical cable, a twisted pair, and a digital subscriber line (DSL) and/or a wireless technology such as an infrared ray, radio, and microwaves, the wired technology and/or the wireless technology is included in the definition of a transmission medium.

The terms “system” and “network” used in this specification are interchangeably used.

In this specification, the terms “base station”, “wireless station”, “eNB”, “gNB” “cell”, “sector” “cell group”, “carrier”, and “component carrier” can be interchangeably used in this specification. A base station can be also referred to as the term such as a fixed station, a NodeB, an eNodeB (eNB), an access point, a transmission point, a reception point, a femtocell, or a small cell.

A base station can accommodate one or more (for example, three) cells (also referred to as “sectors”). When a base station accommodates a plurality of cells, the entire coverage area of the base station can be divided into a plurality of smaller areas and a communication service can be also provided in each of the smaller areas using a base station subsystem (for example, an indoor small-sized base station remote radio head (RRH)). The term “cell” or “sector” refers to a part or all of a coverage area of a base station and/or a base station subsystem that provides a communication service in the coverage area.

In this specification, terms such as “mobile station (MS)”, “user terminal”, “user equipment (UE)”, and “terminal” are used interchangeably. The base station is sometimes referred to by a fixed station, a NodeB, an eNodeB (eNB), an access point, a transmission point, a reception point, a femto cell, a small cell, and the like.

A mobile station is referred to as a subscriber station, a mobile unit, a subscriber unit, a radio unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or several other appropriate terms by those skilled in the art.

In addition, the wireless base station in this specification can also be replaced with a user terminal. For example, each mode/embodiment of the present application can be applied to a configuration in which communication between a radio base station and a user terminal is replaced with communication between a plurality of user-to-device (D2D) devices. At this time, the function of the above-described wireless base station 10 can be regarded as a function of the user equipment 20. In addition, words such as “uplink” and “downlink” can also be replaced with “side”. For example, the uplink channel can also be replaced with a side channel.

Similarly, the user terminal in this specification can also be replaced with a wireless base station. At this time, the function of the user terminal 20 described above can be regarded as a function of the wireless base station 10.

In this specification, a specific operation performed by the base station may be also performed by an upper node. In a network formed by one or more network nodes including a base station, it should be apparent that various operations performed for inter-terminal communicate may be performed by a base station, one or more network nodes (for example, a Mobility Management Entity (MME), a Serving-Gateway (S-GW) may be considered, but the present application is not limited thereto) other than the base station, or a combination thereof

The aspects/embodiments described in this specification may be individually used, may be combined, or may be switched during execution. In addition, the order of the process procedure, the sequence, the flowchart, or the like of each aspect/embodiment described in this specification may be interchanged unless there is contradiction. For example, in the method described in this specification, various steps have been proposed in exemplary orders and the present application is not limited to the proposed specific orders.

Each aspect/embodiment described in this specification may be applied to a system in which Long Term Evolution (LTE), LTE-Advanced (LTE-A), LTE-Beyond (LTE-B), Super 3rd Generation Mobile Communication System (SUPER 3G), Advanced International Mobile Telecommunications (IMT-Advanced), 4th generation mobile communication system (4G), 5th generation mobile communication system (5G), Future Radio Access (FRA), New-RAT (Radio Access Technology), New Radio (NR), New Radio Access (NX), Future generation radio Access (FX), Global System for Mobile Communications (GSM (registered trademark)), Code Division Multiple Access 2000 (CDMA2000), Ultra Mobile Broadband (UMB), IEEE 802.11 (Wi-Fi (Registered trademark)), IEEE 802.16 (WiMAX (registered trademark)), IEEE 802.20, Ultra-WideBand (UWB), Bluetooth (registered trademark) and other appropriate systems are used and/or a next generation system extended based on the system.

The description “based on” used in this specification does not imply “based only on” unless otherwise specified. In other words, the description of “based on” implies both of “based only on” and “based at least on.”

When reference is made to elements in which names “first,” “second,” and the like are used in this specification, the number or the order of the elements is not generally limited. The names can be used in this specification as a method to conveniently distinguish two or more elements from each other. Accordingly, reference to first and second elements does not imply that only two elements are employed or the first element is prior to the second element in some ways.

The term “determining” used in this specification may include a wide variety of operations. Regarding the “determining,” for example, calculating, computing, processing, deriving, investigating, looking up (for example, looking up in a table, a database, or another data structure), and ascertaining may be considered as “determining.” In addition, regarding the “determining,” for example, receiving (for example, receiving information), transmitting (for example, transmitting information), inputting, outputting, and accessing (for example, accessing data in a memory) may be considered as “determining”. In addition, regarding the “determining,” for example, resolving, selecting, choosing, establishing, and comparing may be considered as “determining”. That is, the “determining” can include a case in which any operation is “determined.”

The term “connected” or “coupled” or any modification of the term means various types of direct or indirect connection or coupling between two or more elements and can include the presence of one or more intermediate elements between two mutually “connected” or “coupled” elements. The connection or the coupling between elements may be physical connection, logical connection, or any combination thereof. For example, “connection” can also be replaced with “access to”. When the connection or the coupling is used in this specification, two elements can be considered to be mutually “connected” or “coupled” by using one or more electric wires, cables, and/or printed electric connection and using electromagnetic energy such as electromagnetic energy with a wavelength of a radio frequency region, a microwave region, and a light (both visible light and invisible light) region as several non-limited and non-inclusive examples.

The terms “including” and “comprising” are intended to be inclusive as in the term “comprise” as long as “including,” “comprising,” and modifications thereof are used in this specification or the claims. Further, the term “or” used in this specification or the claims is intended not to be exclusive OR.

The present application has been described above in detail, but it is obvious to those skilled in the art that the present application is not limited to the embodiments described in the specification. The present application can be implemented as a modification and modification without departing from the spirit and scope of the present application as defined by the appended claims. Accordingly, the description of the specification is intended to be illustrative, and is not intended to limit the present application.

1. An interaction method for interference coordination information between base stations, comprising:
determining a predetermined beam setup of a base station;
establishing a beam index indicating each beam in the predetermined beam setup and its corresponding status; and
transmitting the beam index to other base stations.

2. The interaction method of claim 1, wherein the status indicates whether each beam is used or a degree to which each beam is interfered.

3. The interaction method of claim 1, wherein the status indicates, with respect to a specific physical resource block, whether each beam is used or a degree to which each beam is interfered.

4. The interaction method of claim 1, wherein the status indicates an interference power corresponding to each beam, and/or an allowed interference power corresponding to each beam, and/or an allowed interference power of each beam corresponding to a different modulation coding mode.

5. The interaction method of claim 1, wherein the status indicates an interference power corresponding to each beam group that includes a predetermined number of beams, and/or an allowed interference power corresponding to each beam group, and/or an allowed interference power of each beam group corresponding to a different modulation coding mode.

6. The interaction method of claim 1, wherein the status indicates an interference power corresponding to each sequence element in a predetermined beam index sequence formed by each beam, and/or an allowed interference power corresponding to each sequence element, and/or an allowed interference power of each sequence element corresponding to a different modulation coding mode,
wherein each sequence element includes one or more beams.

7. A method for mitigating cross-link interference between base stations, comprising:
receiving beam-associated interference coordination information from other base stations;
determining, based on the interference coordination information, beam-associated interference status information; and
adjusting, based on the interference status information, a power and/or a modulation coding mode of each beam.

8. The method of claim 7, wherein the beam-associated interference coordination information includes one or more of:
beam index information of base stations, physical resource block configuration information, allowed interference power information corresponding to each beam, and interference power information corresponding to each beam.

9. The method of claim 8, wherein the interference status information includes one or more of:
an allowed interference power of each beam of an uplink base station in a different modulation coding mode with respect to a downlink base station;
an interference power caused by each beam of the downlink base station on each beam of the uplink base station;
a total interference power caused by each beam of the downlink base station on the uplink base station; and
a total interference power caused by the downlink base station on each beam of the uplink base station.

10. The method of claim 9, wherein adjusting, based on the interference status information, a power and/or a modulation coding mode of each beam comprises:
generating, by the downlink base station, based on the total interference power caused by each beam of the downlink base station on the uplink base station, a list including priority corresponding to each beam of the downlink base station; and
adjusting, based on the allowed interference power of the uplink base station, a transmission power of the downlink base station according to the priority corresponding to each beam of the downlink base station.

11. The method of claim 9, wherein adjusting, based on the interference status information, a power and/or a modulation coding mode of each beam comprises:
adjusting, based on the interference power of the downlink base station, the modulation coding mode of each beam of the uplink base station according to the allowed interference power of the uplink base station.

12. The method of claim 9, wherein adjusting, based on the interference status information, a power and/or a modulation coding mode of each beam comprises:
generating, by the downlink base station, based on the total interference power caused by each beam on the uplink base station, a list including priority corresponding to each beam of the downlink base station; and
adjusting, based on the allowed interference power of the uplink base station, a transmission power of beam of the downlink base station and/or the modulation coding mode of each beam of the uplink base station, according to the priority corresponding to each beam of the downlink base station.

13. The method of claim 8, wherein the beam index information indicates each beam and its corresponding status, the status indicates whether each beam is used or a degree to which each beam is interfered.

14. A base station, comprising:
an interference coordination information receiving unit configured to receive beam-associated interference coordination information from other base stations;
an interference status information determining unit configured to determine, based on the interference coordination information, beam-associated interference status information; and
an interference adjusting unit configured to adjust, based on the interference status information, a power and/or a modulation coding mode of each beam.

15. The base station of claim 14, wherein the beam-associated interference coordination information includes one or more of:
beam index information of base stations, physical resource block configuration information, allowed interference power information corresponding to each beam, and interference power information corresponding to each beam.

16. The base station of claim 15, wherein the interference status information includes one or more of:
an allowed interference power of each beam of an uplink base station in a different modulation coding mode with respect to a downlink base station;
an interference power caused by each beam of the downlink base station on each beam of the uplink base station;
a total interference power caused by each beam of the downlink base station on the uplink base station; and
a total interference power caused by the downlink base station on each beam of the uplink base station.

17. The base station of claim 16, wherein the interference adjusting unit generates, based on the total interference power caused by each beam on the uplink base station, a list including priority corresponding to each beam of the downlink base station; and
adjusts, based on the allowed interference power of the uplink base station, a transmission power of beam according to the priority corresponding to each beam of the downlink base station.

18. The base station of claim 16, wherein the interference adjusting unit adjusts, based on the interference power of the downlink base station, the modulation coding mode of each beam according to the allowed interference power of the uplink base station.

19. The base station of claim 14, wherein the beam index information indicates each beam and its corresponding status, the status indicates whether each beam is used or a degree to which each beam is interfered.
